(19) United States
(12) Patent Application Publication
(10) Pub. No.: US 2026/0063060 A1
(43) Pub. Date: Mar. 5, 2026

(54) SYSTEMS AND METHODS FOR MANAGING AMMONIA SLIP IN AN AFTERTREATMENT SYSTEM

(71) Applicant: CUMMINS INC., Columbus, IN (US)

(72) Inventors: Thomas R. Nelson, Greenwood, IN (US); Jeffrey Diwakar Abraham, Columbus, IN (US)

(73) Assignee: CUMMINS INC., Columbus, IN (US)

(21) Appl. No.: 19/105,329

(22) PCT Filed: Aug. 29, 2023
(86) PCT No.: PCT/US2023/031428

§ 371 Date: Feb. 20, 2025

Related U.S. Application Data
(60) Provisional application No. 63/402,203, filed on Aug. 30, 2022.

(51) Int. Cl. F01N 3/20; B01D 53/94

(52) U.S. Cl. CPC F01N 3/2066; B01D 53/9418; B01D 53/9495; B01D 2255/911; B01D 2257/404; B01D 2258/012; B01D 2258/018; F01N 2610/02; F01N 2610/146; F01N 2900/1602; F01N 2900/1622

(57) ABSTRACT

A system, method, and apparatus for reducing emissions are provided. A system can include an aftertreatment system including a catalyst, and a controller coupled to the aftertreatment system. The controller is configured to: receive temperature data indicative of a temperature proximate to an inlet for the aftertreatment system; determine, based on the temperature data regarding the temperature proximate to the inlet for the aftertreatment system, a temperature of the catalyst after a predetermined duration subsequent to the received temperature data; receive reductant information regarding an estimate of stored reductant in a portion of the aftertreatment system; determine that the received reductant information regarding the estimate of stored reductant satisfies a threshold reductant value, the threshold reductant value corresponding with the temperature of the catalyst; and adjust, during the predetermined duration, reductant storage in the aftertreatment system based on the received reductant information satisfying the threshold reductant value.

### CROSS-REFERENCE TO RELATED APPLICATION

This application claims the benefit of and priority to U.S. Provisional Application No. 63/402,203, filed Aug. 30, 2022, titled “SYSTEMS AND METHODS FOR MANAGING AMMONIA SLIP IN AN AFTERTREATMENT SYSTEM,” which is incorporated herein by reference in its entirety.

### TECHNICAL FIELD

The present disclosure relates to exhaust aftertreatment systems. More particularly, the present disclosure relates to managing ammonia slip in an aftertreatment system.

### BACKGROUND

Exhaust aftertreatment systems can include various catalysts (e.g., a selective catalytic reduction system, a diesel oxidation catalyst, etc.), and, among other components or systems, reductant dosing systems that introduce a reductant (e.g., urea, diesel exhaust fluid (DEF), ammonia solutions, etc.) to reduce nitrous oxide (NOx) emissions from the system. With emissions regulations expected to become more stringent in the coming years, it is desirable to effectively mitigate certain exhaust gas constituent emissions.

### SUMMARY

In some aspects, this disclosure is directed to a system, method, or apparatus for managing ammonia slip in an aftertreatment system. The system, method, or apparatus can include an aftertreatment system. The aftertreatment system can include a catalyst. The controller can receive temperature data indicative of a temperature proximate to an inlet for the aftertreatment system. The controller can determine, based on the temperature data regarding the temperature proximate to the inlet for the aftertreatment system, a temperature of the catalyst after a predetermined duration subsequent to the received temperature data. The controller can receive reductant information regarding an estimate of stored reductant in a portion of the aftertreatment system. The controller can determine that the received reductant information regarding the estimate of stored reductant satisfies the threshold reductant value, the threshold reductant value corresponding with the temperature of the catalyst. The controller can adjust, during the predetermined duration, reductant storage in the aftertreatment system based on the received reductant information satisfying the threshold reductant value.

In some implementations, the controller can determine, based on the temperature data regarding the temperature proximate to the inlet for the aftertreatment system, a time duration for a current temperature of the catalyst to reach a predicted temperature of the catalyst, the predicted temperature satisfying a temperature threshold to adjust the reductant storage. The controller can adjust, during the time duration, the reductant storage based on a reductant capacity of the catalyst associated with the predicted temperature, the reductant capacity corresponding to a maximum reductant amount or a minimum reductant amount.

In some implementations, the controller can increase the reductant storage based on the reductant information less than the threshold reductant value associated with the temperature of the catalyst. In some implementations, the controller can decrease the reductant storage based on the reductant information greater than the threshold reductant value associated with the temperature of the catalyst.

In some implementations, to determine the temperature of the catalyst, the controller can determine, based on the temperature data regarding the temperature proximate to the inlet for the aftertreatment system, a time duration for a current temperature of the catalyst to reach a predicted temperature of the catalyst, the predicted temperature satisfying a temperature threshold to adjust the reductant storage. The controller can adjust, during the time duration, the reductant storage based on a reductant capacity of the catalyst associated with the predicted temperature.

In some implementations, the reductant capacity can correspond to a maximum reductant amount to adjust during the time duration. In some implementations, the reductant capacity can correspond to a minimum reductant amount to adjust during the time duration. In some implementations, to adjust the reductant storage, the controller can send a signal to a doser to increase, decrease, or maintain a reductant dosing level.

In some implementations, to adjust the reductant storage, the controller can adjust, during the predetermined duration, the reductant storage in the aftertreatment system based on the received reductant information satisfying the threshold reductant value and an exhaust flow rate. In some implementations, the controller can maintain the reductant storage when the exhaust flow rate is less than a predetermined minimum threshold. In some implementations, the controller can increase the reductant storage when the exhaust flow rate is greater than or equal to a predetermined maximum threshold.

In some implementations, the temperature of the catalyst can be a bed temperature of the catalyst. In some implementations, the controller can receive degradation information of the catalyst. The controller can receive, based on the degradation information, an indication of a storage capacity associated with the reductant storage, wherein the reductant storage is adjusted based on the storage capacity.

In certain aspects, this disclosure is directed to a method. The method includes: receiving, by a controller coupled to an aftertreatment system including a catalyst, temperature data indicative of a temperature proximate to an inlet for the aftertreatment system; determining, by the controller, based on the temperature data regarding the temperature proximate to the inlet for the aftertreatment system, a temperature of the catalyst after a predetermined duration subsequent to the received temperature data; receiving, by the controller, reductant information regarding an estimate of stored reductant in a portion of the aftertreatment system; determining, by the controller, that the received reductant information regarding the estimate of stored reductant satisfies a threshold reductant value, the threshold reductant value corresponding with the temperature of the catalyst; and adjusting, by the controller, during the predetermined duration, reductant storage in the aftertreatment system based on the received reductant information satisfying the threshold reductant value.

In some implementations, determining the temperature of the catalyst, the method can include determining, by the controller, based on the temperature data regarding the temperature proximate to the inlet for the aftertreatment system, a time duration for a current temperature of the catalyst to reach a predicted temperature of the catalyst, the predicted temperature satisfying a temperature threshold to adjust the reductant storage. The method can include adjusting, by the controller, during the time duration, the reductant storage based on a reductant capacity of the catalyst associated with the predicted temperature. In some implementations, the reductant capacity can correspond to a maximum reductant amount to adjust during the time duration. In some implementations, the reductant capacity can correspond to a minimum reductant amount to adjust during the time duration. In some implementations, the method can include increasing the reductant storage based on the reductant information being less than the threshold reductant value associated with the temperature of the catalyst. In some implementations, the method can include decreasing the reductant storage based on the reductant information being greater than or equal to the threshold reductant value associated with the temperature of the catalyst.

In certain aspects, this disclosure is directed to a processing circuit for managing reductant slip in an aftertreatment system. The processing circuit can include one or more processors and one or more memory devices coupled to the one or more processors. The one or more memory devices can store instructions executable by the one or more processors that cause the one or more processors to: receive temperature data indicative of a temperature proximate to an inlet for an aftertreatment system; determine, based on the temperature data regarding the temperature proximate to the inlet for the aftertreatment system, a temperature of a catalyst after a predetermined duration subsequent to the received temperature data; receive reductant information regarding an estimate of stored reductant in a portion of the aftertreatment system; determine that the received reductant information regarding the estimate of stored reductant satisfies a threshold reductant value, the threshold reductant value corresponding with the temperature of the catalyst; and adjust, during the predetermined duration, reductant storage in the aftertreatment system based on the received reductant information satisfying the threshold reductant value. In some implementations, to adjust the reductant storage, the instructions, when executed by the one or more processors, further cause the one or more processors to: send a signal to a doser to increase, decrease, or maintain a reductant dosing level.

These and other features, together with the organization and manner of operation thereof, will become apparent from the following detailed description when taken in conjunction with the accompanying drawings. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a schematic diagram of an engine-exhaust aftertreatment system coupled to a controller, according to an example embodiment.

FIG. 2 is a schematic diagram of the controller of the system of FIG. 1, according to an example embodiment.

FIG. 3 are a series plots of time (x-axis) relative to ammonia (NH3) measurements at the outlet of a certain aftertreatment system component (top plot), time relative to a temperature at an inlet of an aftertreatment system component (middle plot), and time relative to an exhaust gas flow rate through an aftertreatment system (bottom plot), according to various example embodiments.

FIG. 4 is a graph depicting a correlation between the temperature of a catalyst relative to a reductant storage of the catalyst, according to an example embodiment.

FIG. 5 is a flow diagram of a method for managing ammonia slip in an aftertreatment system using the controller of FIGS. 1-2, according to an example embodiment.

FIG. 6 is a flow diagram of another method for managing ammonia slip in an aftertreatment system using the controller of FIGS. 1-2, according to an example embodiment.

### DETAILED DESCRIPTION

Following below are more detailed descriptions of various concepts related to, and implementations of, methods, apparatuses, and systems for predicting and controlling ammonia slip from an exhaust aftertreatment system. The various concepts introduced above and discussed in greater detail below may be implemented in any number of ways, as the concepts described are not limited to any particular manner of implementation. Examples of specific implementations and applications are provided primarily for illustrative purposes.

Referring to the Figures generally, the various embodiments disclosed herein relate to systems, apparatuses, and methods for managing ammonia slip in an aftertreatment system. A key component in aftertreatment systems is a Selective Catalytic Reduction (SCR) system that utilizes a two-step process to reduce harmful NOx emissions present in exhaust gas. First, a doser injects a reductant into the exhaust stream. This reductant may be a urea, diesel exhaust fluid (DEF), Adblue®, a urea water solution (UWS), an aqueous urea solution (e.g., AUS32, etc.), or another similar fluid that chemically binds to particles in the exhaust gas. The reductant may decompose to ammonia (NH3) post-injection. Then, this mixture is run through an SCR catalyst that, when at a certain temperature, causes a reaction in the mixture that converts the harmful NOx particles into pure nitrogen and water. In operation, non-decomposed reductant and non-reacted ammonia may be stored within the catalyst (e.g., SCR catalyst). Ammonia that passes through the aftertreatment system and emitted to the environment is known as “ammonia slip.” The catalyst may be able to store certain amounts of ammonia that may be reacted with exhaust gas in the future. However, due to the fluctuations/changes in the ammonia storage capacity that may be caused by changes in temperature, exhaust flow rate, NOx output or concentration, among other variables, the aftertreatment system may experience ammonia slip if the ammonia amount exceeds the storage capacity. On the other hand, if the ammonia storage is not at a desired level (e.g., an amount of ammonia stored in the catalyst to convert the amount of NOx of the exhaust gas into less harmful emissions), the SCR system may experience NOx emissions above a predefined acceptable threshold. Therefore, it is desired to determine or predict the capacity for storing ammonia over time and adjust/correct/modify the ammonia stored in the catalyst (e.g., reductant storage or ammonia storage) based on the storage capacity, thereby minimizing or avoiding ammonia slip above a predefined acceptable threshold.

The systems and methods of the technical solution discussed herein include a controller coupled to an exhaust gas aftertreatment system that includes a selective catalytic reduction (SCR) system (which includes an SCR catalyst), a reductant dosing system structured to introduce or dose reductant into an exhaust gas stream, and an exhaust gas recirculation (EGR) system (in some embodiments, the system does not include an EGR system), among potentially other components, devices, and/or systems. Upon introducing or dosing an amount of reductant into the exhaust gas stream, the SCR system performs a chemical reaction to convert NOx emissions from the engine to less harmful compounds due to the reaction with the catalyst of the SCR and the reductant (e.g., into water and Nitrogen, etc.). Further, the reductant and aspects thereof, such as ammonia, can be stored in the catalyst (e.g., SCR catalyst) to be chemically reacted with the exhaust product (e.g., NOx, etc.) from the engine. With respect to ammonia, the amount of ammonia stored in the catalyst fluctuates (e.g., increases and decreases) over time, based on at least on the reductant dosage amount/frequency, exhaust flow rate, NOx from the engine, etc. The catalyst includes a storage capacity, which indicates a maximum amount of ammonia that may be stored within or by the catalyst. Upon exceeding the storage capacity, an excess amount of ammonia may slip through the catalyst and be emitted into the environment. However, since the storage capacity (e.g., ammonia storage) of the catalyst varies based on at least the aforementioned variables, such as temperature, exhaust flow rate, amount of NOx from the engine over time, etc., it can be challenging to determine changes in the storage capacity and adjust the ammonia stored in the catalyst accordingly.

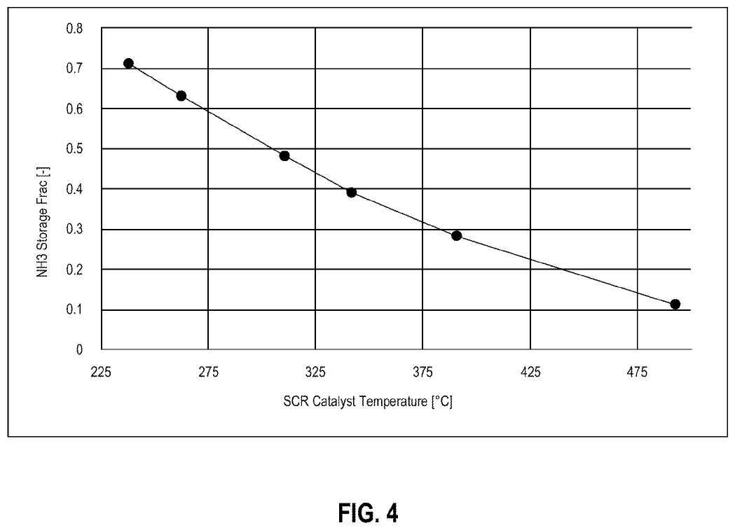

The systems and methods of the technical solution discussed herein can optimize the dosing strategy of the reductant to affect the storage of the ammonia by determining or predicting changes in the storage capacity and adjusting the amount of ammonia stored in the catalyst to minimize or avoid ammonia emissions above a predefined acceptable threshold. For example, the systems and methods can include a controller (or control system) for managing the ammonia storage. The controller determines an ammonia storage target (e.g., a desired level or amount of ammonia stored on/in the catalyst) based on at least a temperature upstream from the catalyst. Using the information regarding the upstream temperature, the controller determines the temperature of the catalyst after a predetermined duration for determining the storage target. For instance, based on exposing the catalyst at a current temperature to the upstream temperature, the controller can determine at least a rate of change (e.g., ascending rate or descending rate) of the temperature and a predicted temperature of the catalyst after a predefined duration of time. The controller can use a heat transfer or temperature change computation technique or process to determine the rate of temperature change. Additionally or alternatively, and further using the upstream temperature, the controller can determine a duration (e.g., time constant) when the current temperature of the catalyst changes (e.g., increase or decrease) to a desired or predetermined temperature. By using the upstream temperature, the controller determines, estimates, and/or predicts changes to the catalyst temperature. In one embodiment, the determined temperature of the catalyst corresponds to an ammonia storage capacity of the catalyst (e.g., described in conjunction with FIG. 4). Based on this value, the controller adjusts the ammonia storage of the catalyst, such as in anticipation or prediction of an upcoming temperature event (e.g., changes in the temperature). For example, during a reduction of ammonia storage capacity as the catalyst temperature increases, the controller maintains or decreases the ammonia storage (e.g., the amount of ammonia stored in the SCR catalyst) by at least one of decreasing or stopping the ammonia dosage (reductant dosing) or increasing an engine-out NOx amount to reduce the ammonia storage (e.g., via the chemical reaction of ammonia with the generated NOx). Beneficially, the systems and methods described herein may mitigate ammonia slip by appropriately tuning ammonia storage capacity to the expected exhaust gas emissions.

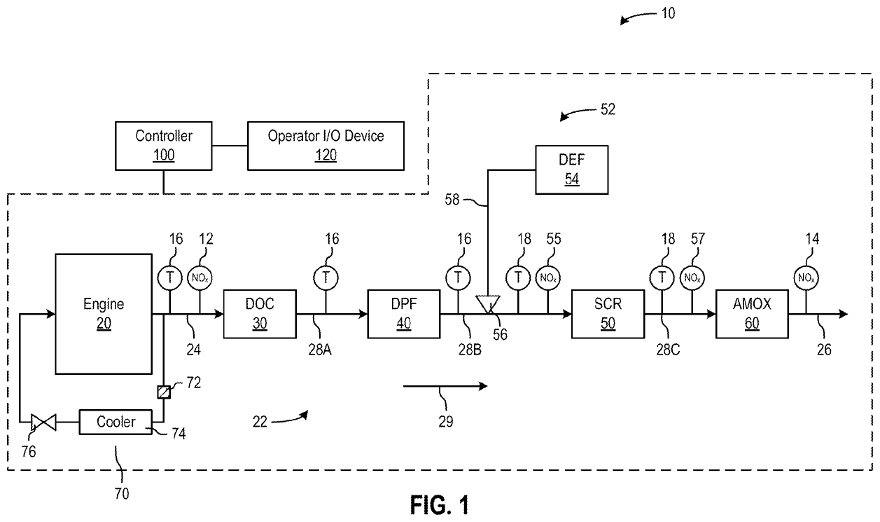

Referring now to FIG. 1 and as shown, a schematic diagram of an engine-exhaust aftertreatment system with a controller 100 is shown, according to an example embodiment. The system 10 is shown as an engine-exhaust aftertreatment system. The system 10 includes an internal combustion engine 20 coupled to an exhaust aftertreatment system 22 that is in exhaust gas-receiving communication with the engine 20. A controller 100 is coupled to the system along with an operator input/output (I/O) device 120. The system 10 may be embodied in a vehicle. The vehicle may include an on-road or an off-road vehicle including, but not limited to, line-haul trucks, mid-range trucks (e.g., pick-up trucks), cars, boats, tanks, airplanes, locomotives, mining equipment, and any other type of vehicle. The vehicle may include a transmission, a fueling system, one or more additional vehicle subsystems, etc. In this regard, the vehicle may include additional, less, and/or different components/systems, such that the principles, methods, systems, apparatuses, processes, and the like of the present disclosure are intended to be applicable with any other vehicle configuration. It should also be understood that the principles of the present disclosure should not be interpreted to be limited to vehicles; rather, the present disclosure is also applicable with stationary pieces of equipment such as a power generator or genset.

In the example shown, the engine 20 is an internal combustion engine that is structured as a compression-ignition internal combustion engine that utilizes diesel fuel. In various other embodiments, the engine 20 may be structured as any other type of engine (e.g., spark-ignition) that utilizes any type of fuel (e.g., gasoline, natural gas, etc.). In some embodiments, the vehicle may be another type of vehicle, such as a hybrid vehicle containing one or more electric motors, a fuel cell vehicle, and so on. Thus, while the engine 20 is structured as a diesel-powered internal combustion engine herein, other embodiments are contemplated to fall within the scope of the present disclosure.

Within the internal combustion engine 20, air from the atmosphere is combined with fuel and combusted to power the engine. Combustion of the fuel and air in the compression chambers of the engine 20 produces exhaust gas that is operatively vented to an exhaust manifold (not shown) and to the aftertreatment system 22.

The exhaust aftertreatment system 22 may include a diesel particulate filter (DPF) 40, a diesel oxidation catalyst (DOC) 30, a selective catalytic reduction (SCR) system 52 with an SCR catalyst 50, an ammonia oxidation (AMOx) catalyst 60, an exhaust gas recirculation (EGR) system 70, an electric heater (not shown), a light-off SCR (not shown), among other architectures or components.

In some embodiments, the aftertreatment system 22 may include a second SCR system. In these embodiments, the aftertreatment system 22 may also include a second DEF doser, a second DPF, a second heater, etc. The second SCR system may be provided upstream or downstream of the (first) SCR system 52. The second DEF doser may be provided upstream of the second SCR. In some embodiments, the second SCR and second DEF doser are substantially similar to the SCR and the DEF doser. In this way and in some embodiments, the aftertreatment system 22 may include one or more of multiple DOCs, DPFs, SCR catalysts, AMOx catalysts, etc. The SCR system 52 further includes a reductant delivery system that has a diesel exhaust fluid (DEF) source 54 (or other type of reductant) that supplies DEF to a DEF doser 56 via a DEF line 58.

In an exhaust flow direction, as indicated by directional arrow 29, exhaust gas flows from the engine 20 into inlet piping 24 of the exhaust aftertreatment system 22. From the inlet piping 24, the exhaust gas flows into the DOC 30 and exits the DOC into a first section of exhaust piping 28A. From the first section of exhaust piping 28A, the exhaust gas flows into the DPF 40 and exits the DPF into a second section of exhaust piping 28B. From the second section of exhaust piping 28B, the exhaust gas flows into the SCR catalyst 50 and exits the SCR catalyst into the third section of exhaust piping 28C. As the exhaust gas flows through the second section of exhaust piping 28B, it is periodically dosed with DEF (reductant) by the DEF (or reductant) doser 56. Accordingly, the second section of exhaust piping 28B acts as a decomposition chamber or tube to facilitate the decomposition of the DEF to ammonia. From the third section of exhaust piping 28C, the exhaust gas flows into the AMOx catalyst 60 and exits the AMOx catalyst into outlet piping 26 before the exhaust gas is expelled from the system 22. Based on the foregoing, in the illustrated embodiment, the DOC 30 is positioned upstream of the DPF 40 and the SCR catalyst 50, and the SCR catalyst 50 is positioned downstream of the DPF 40 and upstream of the AMOx catalyst 60. However, in alternative embodiments, other arrangements of the components of the exhaust aftertreatment system 22 are also possible.

The DOC 30 may be structured to have any number of different types of flow-through designs. The DOC 30 may be structured to oxidize at least some particulate matter in the exhaust (e.g., the soluble organic fraction of soot) and reduce unburned hydrocarbons and CO in the exhaust to less environmentally harmful compounds. For example, the DOC 30 may be structured to reduce the hydrocarbon and CO concentrations in the exhaust to meet the requisite emissions standards for those components of the exhaust gas.

In addition to treating the hydrocarbon and CO concentrations in the exhaust gas, the DOC 30 may also be used in the controlled regeneration of the DPF 40, SCR catalyst 50, and AMOx catalyst 60. This can be accomplished through the injection, or dosing, of unburned HC into the exhaust gas upstream of the DOC 30. Upon contact with the DOC 30, the unburned HC undergoes an exothermic oxidation reaction which leads to an increase in the temperature of the exhaust gas exiting the DOC 30 and subsequently entering the DPF 40, SCR catalyst 50, and/or the AMOx catalyst 60. The amount of unburned HC added to the exhaust gas is selected to achieve the desired temperature increase or target controlled regeneration temperature.

The DPF 40 may be any of various flow-through designs, and is structured to reduce particulate matter concentrations (e.g., soot and ash) in the exhaust gas to meet requisite emission standards. The DPF 40 captures particulate matter and other constituents, and thus can be periodically regenerated to burn off the captured constituents. Additionally, the DPF 40 may be structured to oxidize NO to form NO₂ independent of the DOC 30.

As discussed above, the SCR system 52 includes a reductant delivery system with a reductant (e.g., DEF) source 54, pump (not shown), and delivery mechanism or doser 56. The reductant source 54 can be a container or tank capable of retaining a reductant, such as, for example, ammonia (NH₃), DEF (e.g., urea), diesel oil, etc. The reductant source 54 is in reductant supplying communication with the pump, which is structured to pump reductant from the reductant source 54 to the delivery mechanism 56 via a reductant delivery line 58. The delivery mechanism 56 is positioned upstream of the SCR catalyst 50. The delivery mechanism 56 is selectively controllable to inject reductant directly into the exhaust gas stream prior to entering the SCR catalyst 50. As described herein, the controller 100 is structured to control the timing and amount of the reductant delivered to the exhaust gas. The reductant may decompose to produce ammonia. As briefly described above, the ammonia reacts with NOx in the presence of the SCR catalyst 50 to reduce the NOx to less harmful emissions, such as N₂ and H₂O. The NOx in the exhaust gas stream includes NO₂ and NO. Both NO₂ and NO are reduced to N₂ and H₂O through various chemical reactions driven by the catalytic elements of the SCR catalyst in the presence of NH₃.

The SCR catalyst 50 may be any of various catalysts. For example, in some implementations, the SCR catalyst 50 is a vanadium-based catalyst, and in other implementations, the SCR catalyst is a zeolite-based catalyst, such as a Cu-Zeolite or a Fe-Zeolite catalyst. In one representative embodiment, the reductant is aqueous urea and the SCR catalyst 50 is a zeolite-based catalyst. In other embodiments, the reductant includes a first reductant and a second reductant, wherein the first reductant is urea and the second reductant is ammonia.

The AMOx catalyst 60 may be any of various flow-through catalysts structured to react with ammonia to produce mainly nitrogen. As briefly described above, the AMOx catalyst 60 is structured to remove ammonia that has slipped through or exited the SCR catalyst 50 without reacting with NOₓ in the exhaust. In certain instances, the aftertreatment system 22 can be operable with or without an AMOx catalyst. Further, although the AMOx catalyst 60 is shown as a separate unit from the SCR system 52 in FIG. 1, in some implementations, the AMOx catalyst may be integrated with the SCR catalyst (e.g., the AMOx catalyst and the SCR catalyst can be located within the same housing). In some embodiments, the SCR catalyst and AMOx catalyst are positioned serially with the SCR catalyst preceding the AMOx catalyst. As referred to herein, the SCR catalyst 50 and AMOx catalyst 60 form the SCR and AMOx system. Accordingly, health or degradations determined are in regard to those catalysts.

Various sensors, such as NOx sensors 12, 14, 55, 57 and temperature sensors 16, 18, may be strategically disposed throughout the exhaust aftertreatment system 22 and may be in communication with the controller 100 and structured to monitor operating conditions of the system 10. It should be understood that one or more flow, pressure, and a variety of other sensors (oxygen sensors, exhaust gas constituent sensors, NH3 sensors) may also be included in the system and disposed in a variety of locations. As shown, more than one NOx sensor may be positioned upstream and downstream of the SCR catalyst 50. In this configuration, the NOx sensor 12 measures the engine out NOx while NOx sensor 55 measures the SCR catalyst 50 inlet NOx amount. This is due to DOC 30/DPF 40 potentially oxidizing some portion of the engine out NOx whereby the engine out NOx amount may not be equal to the SCR catalyst 50 inlet NOx amount. Accordingly, this configuration accounts for this potential discrepancy. The NOx amount leaving the SCR catalyst 50 may be measured by NOx sensor 57 and/or NOx sensor 14. In some embodiments, there may be only one such sensor, such as either one of either NOx sensor 57 or NOx sensor 14. The NOx sensor 57 (in some embodiments, NOx sensor 14) is positioned downstream of the SCR catalyst 50 and structured to detect the concentration of NOx in the exhaust gas downstream of the SCR catalyst (e.g., exiting the SCR catalyst).

The temperature sensors 16 are associated with the DOC 30 and DPF 40, and thus can be defined as DOC/DPF temperature sensors 16. The DOC/DPF temperature sensors are strategically positioned to detect the temperature of exhaust gas flowing into the DOC 30, out of the DOC and into the DPF 40, and out of the DPF before being dosed with DEF by the doser 56. The temperature sensors 18 are associated with the SCR catalyst 50 and thus can be defined as SCR temperature sensors 18. The SCR temperature sensors 18 are strategically positioned to detect the temperature of the exhaust gas flowing into and out of the SCR catalyst 50.

The EGR system 70 is structured to recirculate exhaust gas back to an intake manifold of the engine 20 to be used for combustion. The EGR system 70 includes an EGR cooler 74 and an EGR valve 76. The EGR cooler 74 is structured as any type of heat exchanger typically included in EGR systems including, but not limited to, air-to-air and/or liquid (e.g., coolant)-to-air (e.g., exhaust gas) heat exchangers. The EGR cooler 74 is structured to remove heat from the exhaust gas prior to the exhaust gas being re-introduced into the intake manifold. Heat is removed from the exhaust gas prior to reintroduction to, among other reasons, prevent high intake temperatures that could promote pre-ignition (e.g., engine knock).

Although the exhaust aftertreatment system 22 shown includes one of a DOC 30, DPF 40, SCR catalyst 50, and AMOx catalyst 60 positioned in specific locations relative to each other along the exhaust flow path, in other embodiments, the exhaust aftertreatment system may include more than one of any of the various catalysts positioned in any of various positions relative to each other along the exhaust flow path. Additionally, although the DOC 30 and AMOx catalyst 60 are non-selective catalysts, in some embodiments, the DOC and AMOx catalyst can be selective catalysts. Further, the EGR system 70 may include other flow paths, or components not described above.

FIG. 1 is also shown to include an operator input/output (I/O) device 120. The operator I/O device 120 is communicably coupled to the controller 100, such that information may be exchanged between the controller 100 and the I/O device 120. The information exchanged between the controller 100 and the I/O device 120 may relate to one or more components of FIG. 1 or any of the determinations of the controller 100 disclosed herein. The operator I/O device 120 enables an operator of the vehicle (or an occupant of the vehicle) to communicate with the controller 100 and other components of the vehicle, such as those illustrated in FIG. 1. For example, the operator input/output device 120 may include an interactive display, a touchscreen device, one or more buttons and switches, voice command receivers, etc.

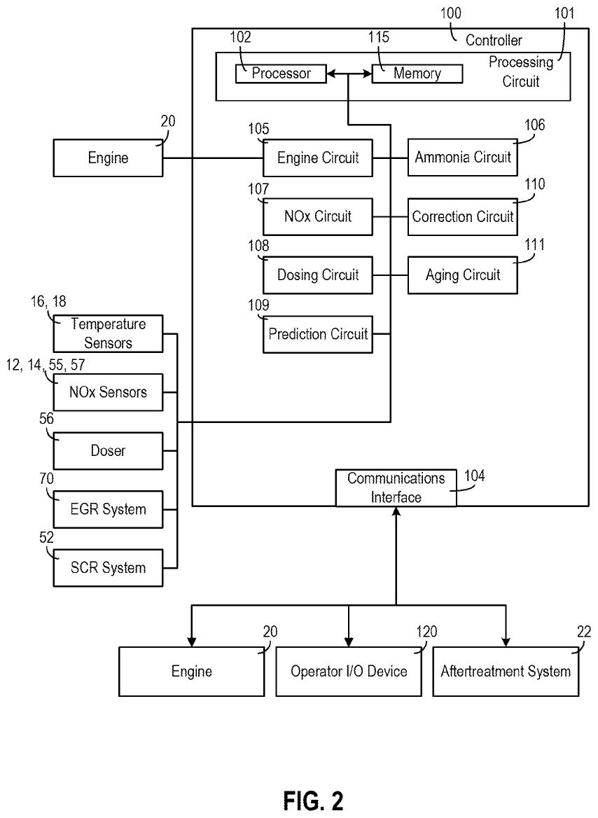

The controller 100 is structured to control, at least partly, the operation of the system 10 and associated sub-systems, such as the internal combustion engine 20 and the exhaust aftertreatment system 22. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (“CAN”) bus provides the exchange of signals, information, and/or data. The CAN bus includes any number of wired and wireless connections. Because the controller 100 is communicably coupled to the systems and components of FIG. 1, the controller 100 is structured to receive data from one or more of the components shown in FIG. 1. For example, the data may include NOx data (e.g., an incoming NOx amount from NOx sensor 55 and an outgoing NOx amount from NOx sensor 57), dosing data (e.g., timing and amount of dosing delivered from doser 56), and vehicle operating data (e.g., engine speed, vehicle speed, engine temperature, etc.) received via one or more sensors. As another example, the data may include an input from operator input/output device 120. As described more fully herein, using this data, the controller 100 manages or adjusts the ammonia storage of the catalyst (e.g., SCR catalyst 50, etc.), such as by controlling one or more components of the system 10 including at least the doser 56 for reductant dosing (e.g., increasing, reducing or stopping reductant dosage), modifying operation of the internal combustion engine 20 to affect NOx output to affect ammonia storage, etc. The structure and function of the controller 100 are further described in regard to FIG. 2.

FIG. 2 shows an example structure for the controller 100 that includes a processing circuit 101 including a processor 102, a memory 115, and various circuits including at least an engine circuit 105, ammonia circuit 106, NOx circuit 107, dosing circuit 108, prediction circuit 109, correction circuit 110, and aging circuit 111. The processor 102 may be implemented as one or more processors, application specific integrated circuits (ASICs), field programmable gate arrays (FPGAs), digital signal processors (DSPs), a group of processing components, or other suitable electronic processing components. The memory 115 (e.g., RAM, ROM, Flash Memory, hard disk storage, etc.) may store data and/or computer code for facilitating the various processes described herein. The memory 115 may be communicably connected to the processor 102 and one or more circuits (e.g., engine circuit 105, ammonia circuit 106, NOx circuit 107, dosing circuit 108, prediction circuit 109, correction circuit 110, and aging circuit 111) and structured to provide computer code or instructions to the processor 102 for executing the processes described in regard to the controller 100 herein. Moreover, the memory 115 may be or include tangible, non-transient volatile memory or non-volatile memory. Accordingly, the memory 115 may include database components, object code components, script components, or any other type of information structure for supporting the various activities and information structures described herein.

The controller 100 is structured to receive inputs (e.g., signals, information, data, etc.) from the system 10 components/systems and/or operator I/O device 120. The controller 100 is further structured to control, at least partly, the system 10 components/systems and associated vehicle. As the components of FIG. 2 can be embodied in a vehicle, the controller 100 may be structured as one or more electronic control units (ECUs). The controller 100 may be separate from or included with at least one of a transmission control unit, an exhaust aftertreatment control unit, a powertrain control module, an engine control module, etc.

In one configuration, one or more circuits (e.g., engine circuit 105, ammonia circuit 106, NOx circuit 107, dosing circuit 108, prediction circuit 109, correction circuit 110, and aging circuit 111) can be embodied as machine or computer-readable media that stores instructions that are executable by a processor, such as processor 102, and stored in a memory device, such as memory 115. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the one or more circuits are embodied as hardware units, such as electronic control units. As such, the one or more circuits may be embodied as one or more circuitry components including, but not limited to, processing circuitry, network interfaces, peripheral devices, input devices, output devices, sensors, etc. In some embodiments, the one or more circuits may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the one or more circuits may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, capacitors, inductors, diodes, wiring, and so on). The one or more circuits may also include programmable hardware devices such as field programmable gate arrays, programmable array logic, programmable logic devices or the like. The one or more circuits may include one or more memory devices for storing instructions that are executable by the processor(s) of the individual circuits (e.g., engine circuit 105, ammonia circuit 106, NOx circuit 107, dosing circuit 108, prediction circuit 109, correction circuit 110, and aging circuit 111). The one or more memory devices and processor(s) may have the same definition as provided below with respect to the memory 115 and processor 102. In some hardware unit configurations, one or more of the circuits may be geographically dispersed throughout separate locations in, for example, a vehicle. Alternatively and as shown, the one or more circuits may be embodied in or within a single unit/housing, which is shown as the controller 100.

The processing circuit 101 may be structured or configured to execute or implement the instructions, commands, and/or control processes described herein with respect to at least one of the engine circuit 105, ammonia circuit 106, NOx circuit 107, dosing circuit 108, prediction circuit 109, correction circuit 110, or the aging circuit 111. The depicted configuration represents the engine circuit 105, ammonia circuit 106, NOx circuit 107, dosing circuit 108, prediction circuit 109, correction circuit 110, and aging circuit 111 as instructions in machine or computer-readable media. In some embodiments, the instructions may be stored by the memory device. However, as mentioned above, this illustration is not meant to be limiting as the present disclosure contemplates other embodiments where the engine circuit 105, ammonia circuit 106, NOx circuit 107, dosing circuit 108, prediction circuit 109, correction circuit 110, and aging circuit 111, or at least one of the one or more circuits, is configured as a hardware unit. All such combinations and variations are intended to fall within the scope of the present disclosure.

In the example shown, the controller 100 includes at least an engine circuit 105 structured to control the engine 20, a NOx circuit 107 in communication with the NOx sensors 12, 14, 55, 57, an ammonia circuit 106 in communication with sensors associated with the SCR catalyst 50 and/or the AMOx catalyst 60, a dosing circuit 108 structured to control operation of the reductant dosing system (e.g., DEF source 54 and/or doser 56), a prediction circuit 109 configured to determine or predict the temperature or the ammonia storage level of the catalyst, a correction circuit 110 structured to determine an adjustment for the determined ammonia storage, thereby signaling the dosing circuit to adjust the ammonia dosage and/or signaling the engine 20 to increase, reduce, or otherwise adjust an engine-out NOx amount to control an ammonia storage of the catalyst, and an aging circuit 111 structured to determine the degradation of one or more components (e.g., SCR catalyst 50, etc.) over time. As described herein, adjusting a reductant dosing amount and/or modifying an engine out NOx amount function to modify or adjust an ammonia storage amount of the SCR catalyst. In this regard, increasing engine out NOx causes more stored ammonia to react with the NOx to decrease ammonia slip and ammonia storage. Additionally, as catalyst temperatures increase (e.g., due to higher engine loads, etc.), catalyst activity increases so dosing may be decreased to mitigate against slip.

The engine circuit 105 is structured to receive information from a user (e.g., via the operator input/output device 120) and to provide instructions to or otherwise control the engine 20. For instance, the engine circuit 105 can control the operations or components of the engine including at least the intake valve for controlling intake air or gas, the exhaust valve to release the exhaust gas through the pipe (e.g., piping 24, 28A-C, 26, etc.), or other components of the engine 20. Thus, the engine circuit 105 may control a torque and/or speed (and other factors, such as air-to-fuel ratio) from the engine 20 to control an engine-out NOx amount, an engine-out exhaust gas temperature (to affect catalyst temperatures), and so on. The engine circuit 105 is structured to communicate the engine information to one or more other circuits (e.g., prediction circuit 109, correction circuit 110, aging circuit 111, etc.) of the controller 100 and/or to components of the memory 115.

The NOx circuit 107 is coupled to and communicates with the NOx sensors 12, 14, 55, 57 and provides information regarding NOx values (e.g., detected or sensed NOx concentrations or amounts in exhaust gas) to other circuits of the controller 100 and/or to components of the memory 115. The one or more NOx sensor(s) may be virtual NOx sensor(s) or physical NOx sensor(s). The NOx circuit 107 may process raw data received from the NOx sensors 12, 14, 55, 57 in addition to other sensor data to provide information indicative of a NOx value to other circuits of the controller 100 and/or to components of the memory 115.

The ammonia circuit 106 is structured to determine an ammonia storage value indicative of an amount of ammonia stored in or on a catalyst and, particularly, the SCR catalyst 50. The ammonia circuit 106 is structured to communicate with the dosing circuit 108, the temperature sensors 16, 18, and the NOx sensors 12, 14, 55, 57 to determine the ammonia storage value. In some cases, the controller 100 can determine the ammonia storage amount or value based on at least historical reductant dosing amounts, current or anticipated engine-out NOx amounts, current and anticipated temperatures in the aftertreatment system, and so on. In some cases, the controller 100 can receive the ammonia storage indication from one or more sensors coupled to one or more components of the system 10. In various implementations, the ammonia circuit 106 is structured to determine the storage capacity or storage level for storing ammonia in the SCR catalyst 50. The storage capacity indicates a maximum amount of ammonia storage that the SCR catalyst 50 can store, such as based on the temperature of the catalyst 50 (e.g., described in conjunction with FIG. 4). For instance, the ammonia storage can be determined based on at least one suitable empirical formula (e.g., using data from one or more components of the system 10), based on a physics-based or a map-based model, and/or via another suitable method. For example, lab-based results may be used to correlate an ammonia storage amount of a catalyst for various conditions (e.g., age of the catalyst, operating conditions, and so on) in order to determine a maximum amount of ammonia storage for various conditions.

The dosing circuit 108 is structured to provide a dosing command to the doser 56 to control and manage (e.g., adjust) a reductant dosing amount and/or timing from the doser 56. The dosing circuit 108 may also communicate with the ammonia circuit 106 and the NOx circuit 107. For example, the dosing circuit 108 can receive information from the ammonia circuit 106 indicating at least one of a current ammonia storage or ammonia storage capacity of the SCR catalyst 50. In this case, if the ammonia stored in SCR catalyst 50 is less than a threshold value or amount, the dosing circuit 108 can command additional reductant dosing to the exhaust stream to increase the ammonia storage. In a further example, the dosing circuit 108 is structured to receive information from the correction circuit 110 to initiate reductant dosing to adjust the amount of ammonia storage on/in the catalyst.

The controller 100 can also control the engine 20 to adjust the ammonia storage in the catalyst. For example, the controller 100 may command or instruct the engine 20 to increase an engine out NOx output, thereby having more NOx chemically react with the stored ammonia in the catalyst. Hence and in some embodiments, the controller 100 is configured to reduce the ammonia storage by increasing the engine-out NOx.

The prediction circuit 109 is structured to predict or determine the temperature of one or more components of the aftertreatment system 22 (or, of other features in the system, such as the exhaust gas temperature). Hereinafter, the SCR catalyst 50 is used as an example for the operations of one or more circuits of the controller 100. For example, the prediction circuit 109 determines the current temperature of the SCR catalyst 50 and a temperature upstream of the SCR catalyst 50, such as the exhaust gas temperature upstream of the SCR catalyst 50. For instance, the prediction circuit 109 determines the exhaust flow rate upstream or through the SCR catalyst 50 based on one or more sensors (e.g., flow rate sensors) positioned at upstream positions, such as upstream of the SCR catalyst 50. The prediction circuit 109 determines a temperature (e.g., a predicted or another temperature) of the SCR catalyst 50 after a predetermined duration based on the current SCR catalyst 50 temperature and the upstream temperature. The prediction circuit 109 is configured or structured to account for the rise or drop in exhaust gas temperature during its stream to the SCR catalyst 50.

Thus, the prediction circuit 109 is structured or configured to determine the temperature of the SCR catalyst 50 subsequent to a predetermined duration (e.g., configurable by the operator, manufacturer, technician, etc.) based on at least one of the upstream temperature or the exhaust flow rate (e.g., sometimes referred to as flow rate). In some cases, the prediction circuit 109 is structured to determine a time duration (e.g., time constant) to reach a predetermined temperature, such as a desired temperature associated with a certain ammonia storage capacity. For example, based on the upstream temperature, the prediction circuit 109 determines a change to the temperature of the SCR catalyst 50 over a predefined amount of time. The predetermined temperature can be based on the desired ammonia storage capacity. As such, the prediction circuit 109 is structured to determine the amount of time (e.g., time duration or time constant) for the SCR catalyst 50 to reach the predetermined temperature based on the predicted change in temperature over time. In various implementations, the prediction circuit 109 is structured to determine the storage capacity of the SCR catalyst 50 based on the determined temperature of the SCR catalyst 50, such as described in conjunction with FIG. 4.

The correction circuit 110 is structured or configured to determine whether to adjust the ammonia storage based on at least the predicted temperature of the SCR catalyst 50. The correction circuit 110 receives information regarding the predicted temperature from the prediction circuit 109. The correction circuit 110 is structured or configured to signal, communicate, and/or provide instructions to at least one of the dosing circuit 108 to adjust the ammonia storage of the SCR catalyst 50 (or, the controller may adjust the storage directly via controlling HC dosing as described above). For example, the correction circuit 110 is structured or configured to determine, based on at least the current ammonia storage of the SCR catalyst 50 (e.g., determined based on the current temperature, and in some cases, the age or degradation of the SCR catalyst 50) and an expected storage capacity (e.g., determined based on the predicted temperature) after a predetermined duration (or time constant), at least one of the maximum or minimum ammonia storage for the SCR catalyst 50. For instance, information from the correction circuit 110 can enable the dosing circuit 108 to increase or maintain a reductant dosing level if a subsequent storage capacity (e.g., determined based on the predicted temperature after the time constant, indicating an increased or decreased ammonia storage capacity) is greater than a current storage capacity. In another instance, if the subsequent storage capacity is less than the current storage capacity, based on the current ammonia storage exceeding a threshold level (e.g., maximum capacity), the controller 100 causes the engine 20 to generate NOx to chemically react with the excess ammonia (e.g., reducing the ammonia storage to or below the maximum capacity) from the catalyst.

The aging circuit 111 is structured to track changes in the catalyst state, for example, based on or associated with the degradation, wear, aging, deactivation, or changes in the performance of the catalyst. The terms “degradation” and “deactivation” of the catalyst can be interchangeable. For example, the aging circuit 111 is structured to determine changes to the maximum ammonia storage capacity of the SCR catalyst 50, the conversion efficiency of the SCR catalyst 50, among other catalyst states resulting from historical usage, historical regenerations, environmental exposure, etc. over time (e.g., throughout the lifetime of the catalyst or within a predetermined time frame, such as a week, month, year, etc.). The aging circuit 111 is structured to communicate the degradation information of the SCR catalyst 50 (or other components of the controller 100) to one or more circuits (e.g., dosing circuit 108, prediction circuit 109, correction circuit 110, etc.). Based on the degradation, the one or more circuits are structured to manage ammonia dosage to maintain or adjust the ammonia storage in the SCR catalyst 50, thereby avoiding ammonia emissions above a predefined acceptable threshold (e.g., reducing the ammonia storage below the maximum storage capacity, or increasing the ammonia storage to the maximum storage capacity during generation of exhaust product).

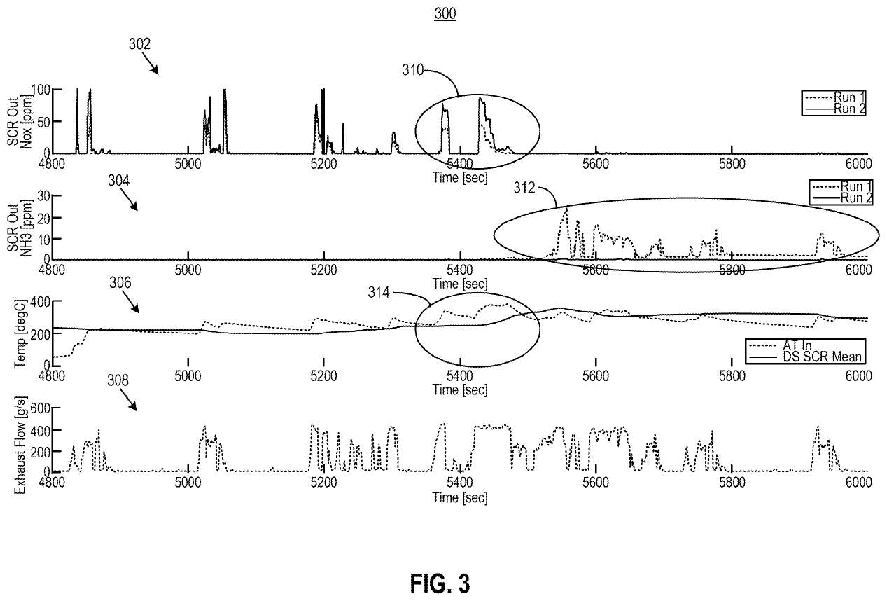

Referring now to FIG. 3, a plot 302 of NH3 measurements at the outlet of a certain aftertreatment system component (particularly, the SCR system) is shown, according to an example embodiment. The plot 302 shows a first set of data points (e.g., shown as “disabled” in the legend) using the catalyst temperature to initiate ammonia dosage (e.g., with ammonia storage management based on predicted temperature disabled), and a second set of data points (e.g., shown as “enabled” in the legend) using at least the catalyst temperature and the inlet temperature of the aftertreatment system 22 to adjust the ammonia dosage (e.g., with ammonia storage management based on predicted temperature enabled). Relative to the first set of data points, the second set of data points includes or corresponds to ammonia emissions based on predicting the temperature of the SCR catalyst according to at least the inlet temperature of the aftertreatment system 22 (e.g., reducing or minimizing ammonia emissions). FIG. 3 also shows a plot 304 of the catalyst temperature (e.g., bed temperature or brick temperature of the SCR catalyst 50, such as the mean temperature, average temperature, etc.) and the inlet temperature of the aftertreatment system 22. FIG. 3 shows another plot 306 of the exhaust flow rate over time. Plots 304 and 306 are associated with the example first set of data points and the second set of data points of the aftertreatment system 22 of plot 302.

Still referring to FIG. 3 and as shown in plot 302, the first set of data points of the aftertreatment system 22 uses the catalyst temperature shown in plot 304 to control ammonia dosing to satisfy or meet an ammonia storage target. For instance and in this example, from 0 second to approximately 200 seconds, the first set of data points depicts performing ammonia dosing based on the low temperature of the SCR catalyst 50. However, due to the rise in temperature, such as around the 300-second mark (e.g., labeled as portion 308), the storage capacity of the SCR catalyst 50 decreases (e.g., at relatively higher temperatures the ammonia storage capacity decreases). Continuing to increase temperature may cause the already dosed ammonia to slip through the aftertreatment system 22, which is undesired. In other words, when ammonia slip occurs, increasing the temperature of the catalyst and system may be undesired due to promoting additional slip. Hence, by dosing the exhaust stream based only on the catalyst temperature, undesired ammonia emission above a predetermined threshold may occur.

As shown in the second set of data points, the controller 100 manages the ammonia emission. The controller 100 (e.g., prediction circuit 109) uses information from upstream temperature signals (e.g., inlet temperature of the SCR catalyst 50) and the catalyst temperature when determining the ammonia storage target. Then, the controller 100 (e.g., the prediction circuit 109) determines the temperature of the SCR catalyst 50 at a subsequent future time. For example, based on the inlet temperature at portion 310 of plot 304, the prediction circuit 109 determines or predicts the change in the catalyst temperature after a time duration (e.g., shown as around 300-400 seconds).

In some cases, the prediction circuit 109 aggregates a duration of inlet temperatures (e.g., over a predefined period of time) to predict the catalyst temperature at a subsequent time. For instance, if the inlet temperature trends upward thereby showing an increase temperature, the prediction circuit 109 may determine that the catalyst temperature after a predetermined time duration may be higher than the aggregated inlet temperature. In another example, if the inlet temperature trends downward thereby showing a decrease in temperature, the prediction circuit 109 may determine that the catalyst temperature after the predetermined time duration may be lower than the aggregated inlet temperature. Additionally or alternatively, the prediction circuit 109 may determine the catalyst temperature after the predetermined time duration based on a fluctuation (e.g., increase and decrease) of the inlet temperature over the aggregated/predefined time duration. The catalyst temperature can represent the ammonia storage capacity of the SCR catalyst 50, and the inlet temperature can represent the ammonia storage capacity of the SCR catalyst 50 after a time duration. For instance, since the catalyst temperature is associated with the ammonia storage capacity, the current catalyst temperature can represent a current ammonia storage capacity, and the inlet temperature (e.g., reflecting the catalyst temperature at a future time period) can reflect the ammonia storage capacity at a future time period.

The controller 100 (e.g., correction circuit 110) compares the current catalyst temperature (e.g., representing a first storage capacity) to the inlet or upstream temperature (e.g., representing a second storage capacity) to determine an ammonia storage target. The ammonia storage target refers to the desired amount of ammonia to store in the SCR catalyst 50 when the current catalyst temperature reaches the desired or predefined temperature after a time duration (e.g., future time period), such that the stored ammonia does not exceed the storage capacity at the future time period. For example, the correction circuit 110 determines the first storage capacity based on the catalyst temperature and the second storage capacity based on the inlet temperature. The correction circuit 110 selects the minimum (or the lower) storage capacity of the compared storage capacities as the ammonia storage target. Accordingly, by accounting for the fluctuation (e.g., increase or decrease) in storage capacity, the correction circuit 110 adjusts the ammonia storage using the selected ammonia storage target to minimize ammonia or potential ammonia emissions from the aftertreatment system 22 (i.e., mitigate ammonia slip). The correction circuit 110 can adjust the ammonia storage during the changes in the temperature of the SCR catalyst 50, such as responsive to setting the ammonia storage target, after a time delay, or before the catalyst temperature reaches the predicted temperature based on the upstream temperature. In some implementations, the controller 100 can use the upstream temperature as the ammonia storage target without the catalyst temperature.

In various implementations, the controller 100 (e.g., correction circuit 110) adjusts the ammonia storage based on the exhaust flow rate. The exhaust flow rate can be associated with the amount of exhaust gas constituents (e.g., NOx) at the inlet of the aftertreatment system 22. For example, the correction circuit 110 can increase the ammonia storage target (or set the storage target based on the higher storage capacity) during a high exhaust flow rate (e.g., exhaust flow rate greater than a predetermined maximum threshold), since the available ammonia stored in the SCR catalyst 50 may react with the exhaust gas constituents at a higher rate due to the higher exhaust flow rate (e.g., higher rate of depletion of the stored ammonia) Otherwise, for example, the correction circuit 110 can adjust the storage target to at least the selected storage capacity (or below the selected storage capacity) during low exhaust flow rate (e.g., exhaust flow rate below a predetermined minimum threshold) or maintain the current amount of stored ammonia. The predetermined thresholds discussed herein may be configured by the operators, a remote computing device (e.g., via over-the-air update), etc.

Referring now to FIG. 4, a graph 400 of a correlation between the temperature of a catalyst and the ammonia storage is shown, according to an example embodiment. The graph 400 includes an x-axis associated with the temperature of the catalyst (e.g., SCR catalyst 50) and a y-axis associated with the ammonia storage fraction. The ammonia storage fraction represents a ratio of ammonia storage against maximum storage capacity (e.g., ammonia storage divided by the maximum storage capacity) at a predetermined or given temperature. For example, the ammonia storage fraction can range from 0 to 1, and the catalyst temperature can range from any operating temperature, such as from 200 degrees Celcius to 500 degrees Celcius. As shown, Applicant has determined that the ammonia storage fraction is inversely proportional to the catalyst temperature. Based this property or characteristic of the ammonia storage capacity, the controller 100 determines the storage capacity of the SCR catalyst 50 based on the catalyst temperature, such as the upstream temperature of the aftertreatment system 22 or the brick temperature of the SCR catalyst 50.

As shown, the storage capacity decreases with an increase in the catalyst temperature. This is due to the temperature burning off stored ammonia that is then released back into the system, unreacted. Conversely, the storage capacity increases with a decrease in the catalyst temperature. By accounting for the fluctuation in the catalyst temperature (e.g., anticipating upcoming temperature events) based on at least one of the exhaust flow rate and the inlet temperature of the aftertreatment system 22, the controller 100 can minimize the ammonia emission before releasing to the AMOX (e.g., AMOX 60, which loses selectivity over time) or from the aftertreatment system 22.

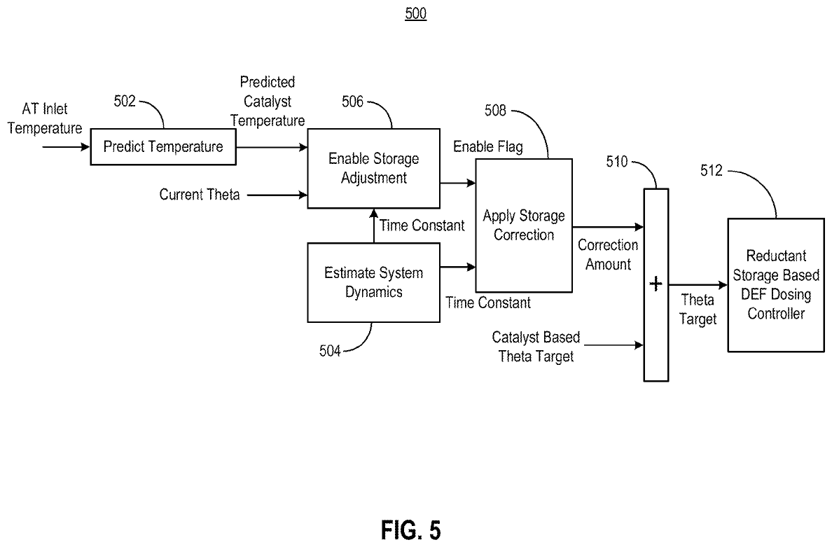

Referring now to FIG. 5, a flow diagram of a method 500 for managing ammonia emission in an aftertreatment system 22 is shown, according to an example embodiment. The method 500 may be performed by the components of FIGS. 1-2, such that reference may be made to them to aid explanation of the method 500. Discussed hereinafter, the method 500 includes processes 502, 504, 506, 508, and 510, among other processes (or other operations) to manage the ammonia storage in the aftertreatment system 22. In various implementations, certain processes can be performed before or after one another, such as process 504 before process 502, among others.

At process 502, the controller 100 (e.g., prediction circuit 109) predicts the temperature (e.g., changes in the temperature) of the SCR catalyst 50 (e.g., catalyst temperature) (e.g., determines the catalyst temperature after a time duration). The controller 100 predicts the catalyst temperature based on at least an inlet temperature of the aftertreatment system 22. For example, the controller 100 receives temperature data (e.g., from at least one of temperature sensors 16 or 18) indicative of a temperature proximate to an inlet for the aftertreatment system 22. Based on the temperature data regarding the temperature proximate to the inlet for the aftertreatment system 22, the controller 100 determines the temperature of the catalyst after a predefined time duration subsequent to the received temperature data.

In some implementations, the duration can be a predetermined duration configured by the operator, technician, etc. For instance, the controller 100 determines the changes in the catalyst temperature after a predetermined duration. In some implementations, the duration corresponds to a time constant (e.g., discussed in process 504). The time constant can refer to a predefined duration to determine the predicted temperature. In some cases, the time constant can indicate a duration for a current temperature (e.g., a first temperature) of the SCR catalyst 50 to reach the predetermined temperature above the current temperature based on the inlet temperature of the aftertreatment system 22 (e.g., the duration for the current temperature of the SCR catalyst 50 to increase or decrease by a predetermined/predefined amount, such as 25, 50, 100 degrees, etc.). For example, based on the temperature data, the controller 100 determines a time duration (e.g., time constant) for a current temperature of the SCR catalyst 50 to reach a predicted temperature for the SCR catalyst 50 (e.g., based on the inlet temperature). In this case, the predefined temperature can be a temperature satisfying (e.g., greater than or less than) a threshold (e.g., a deviation threshold representing a minimum change in temperature) to enable adjustment to the ammonia storage. For instance, the ammonia storage can be adjusted relative to the temperature within predefined ranges, such as when the temperature of the SCR catalyst 50 is at or above an upper threshold, or when the temperature is at or below a lower threshold. The controller 100 determines a time duration to meet or exceed a predefined temperature threshold for the SCR catalyst 50 based on at least the current temperature of the SCR catalyst 50 and the inlet temperature (e.g., upstream temperature) of the aftertreatment system 22. Otherwise, in instances where the temperature does not satisfy the threshold (e.g., when the temperature is within a predefined range including below the upper threshold and above the lower threshold), the controller 100 may not enable adjustment to the ammonia storage.

In various implementations, the controller 100 determines the catalyst temperature based further on the exhaust flow rate. For instance, a higher exhaust flow rate (e.g., 400 g/s) can accelerate the increase of the temperature of the SCR catalyst 50 compared to a lower exhaust flow rate (e.g., 100 g/s).

At process 504, the controller 100 (e.g., prediction circuit 109) determines a time constant (e.g., temperature dynamics time constant) in the aftertreatment system 22 from the inlet of the aftertreament system 22 to the SCR catalyst 50. The time constant represents a time duration for the current temperature of the SCR catalyst 50 (e.g., bed temperature or brick temperature) to reach a predetermined temperature of the SCR catalyst 50. For instance, based on the current ammonia storage amount, the controller 100 determines the desired temperature (e.g., an upper temperature threshold or a lower temperature threshold) relative to the current temperature, such as 25, 50, etc. degrees higher or lower than the current temperature, for adjusting the ammonia storage. The controller 100 determines the time constant, which indicates an approximate time duration for the SCR catalyst 50 to reach either one of the temperature thresholds (e.g., the upper temperature threshold or lower temperature threshold). A greater time constant value represents a relatively extended or longer time duration for the catalyst to reach the desired temperature, and a lower time constant value represents a relatively shorter time duration for the catalyst to reach the desired temperature.

The controller 100 determines the time constant based on at least the current temperature of the catalyst and the exhaust flow rate of the exhaust pipe. In some cases, the exhaust flow rate may be associated with the time constant. For example, with an increase in the exhaust flow rate, the temperature of the catalyst increases at a greater pace, thereby having a lower or smaller time constant. By decreasing the exhaust flow rate, the temperature may increase at a lower rate (e.g., higher time constant) or the temperature may decrease.

At process 506, the controller 100 (e.g., the correction circuit 110) determines when to enable an ammonia storage adjustment. The predicted catalyst temperature (e.g., based on the inlet temperature) represents a deviated temperature from the current catalyst temperature, which indicates whether the ammonia storage is to be adjusted. If the predicted catalyst temperature is not greater than a threshold (e.g., +/−10 degrees Celsius, 20 degrees Celsius, etc.), the ammonia storage may not require adjustment. For example, the controller 100 receives ammonia information regarding an estimate of ammonia stored (i.e., a current theta or current ammonia storage fraction) of at least a portion of the aftertreatment system 22 (e.g., in the catalyst).

The controller 100 determines whether the received ammonia information satisfies a threshold ammonia value (e.g., upper threshold or lower threshold) associated with the temperature of the catalyst (e.g., predicted temperature). The predicted temperature represents the temperature of the catalyst over a predefined amount of time based on the time constant or after a predefined time duration. The predicted temperature may be correlated to an estimated ammonia storage amount (e.g., subsequent ammonia storage capacity). Based on the estimated ammonia storage amount and based on the predicted temperature, the controller 100 determines whether to adjust the current ammonia storage. For instance, if the predicted catalyst temperature is not greater than an upper threshold or not lower than a lower threshold (e.g., +/−10 degrees Celsius, 20 degrees Celsius, etc.), the ammonia storage may not require adjustment. Otherwise, the ammonia storage may be adjusted based on the storage capacity associated with the predicted temperature of the SCR catalyst 50. In FIG. 5, current theta represents the deviation between the amount of ammonia stored in the SCR catalyst 50 and the predicted storage capacity associated with the predicted temperature of the SCR catalyst 50, indicating the adjustment the ammonia storage. By satisfying the threshold (e.g., the stored ammonia (or current theta) is greater than the threshold or less than the threshold), the controller 100 determines to adjust the ammonia storage. Otherwise, if the threshold is not satisfied, the controller 100 determines to maintain the ammonia storage (e.g., the ammonia storage is at the level of reductant for the predicted catalyst temperature).

In various implementations, the controller 100 can determine the current ammonia storage (e.g., the amount of ammonia stored in the SCR catalyst 50) based on one or more sensor(s) (e.g., virtual and/or physical sensor(s)) and/or estimate the ammonia storage. For example, the SCR catalyst 50 may include one or more sensors configured to directly measure an amount of stored ammonia. The controller 100 receives a signal from the one or more sensors with information on the amount of stored ammonia. In another example, the controller 100 can determine the current ammonia storage based on historical data of sensor measurements. For example, the aftertreatment system 22 includes at least one sensor upstream of and at least one sensor downstream from the SCR catalyst 50. An upstream sensor is configured to measure the amount of ammonia dosed into the SCR catalyst 50. Another upstream sensor is configured to measure the amount of byproduct (e.g., NOx) from the engine 20. One or more downstream sensors are configured to measure an amount of ammonia (if any) emitted from the SCR catalyst 50, and the amount of engine byproduct (if any) that is emitted after passing the SCR catalyst 50 (or the conversion rate of the SCR catalyst 50). Based on the input and output information of the SCR catalyst 50 from the sensor(s), the controller 100 determines the current amount of stored ammonia, which may be computed using a virtual sensor.

Using at least the current theta (e.g., current level of stored ammonia), the predicted temperature, and the time constant, the controller 100 determines when to adjust the ammonia storage. For example, the controller 100 uses the predicted temperature to determine at least the maximum storage capacity of the catalyst when the catalyst reaches the predicted temperature. The controller 100 uses the time constant to determine a duration until the current catalyst temperature reaches the predicted temperature. The controller 100 triggers the storage adjustment operation when the time constant is relatively low or small (e.g., high exhaust flow condition, or when the current temperature will reach the predicted temperature within a relatively short predetermined time, such as 5 seconds, 10 seconds, etc.). Further, the controller 100 triggers the storage adjustment operation when the current amount of stored ammonia exceeds the storage capacity. In some embodiments, the controller 100 triggers the ammonia storage adjustment operation when any individual condition (e.g., low time constant or stored ammonia exceeds capacity) is met, or responsive to satisfying all conditions. The controller 100 triggers the storage adjustment operation by enabling a flag or indicator (e.g., correction flag, ammonia dosing flag, etc.).

At process 508, the controller 100 uses the current amount of stored ammonia to determine the adjustment to the ammonia storage to satisfy (e.g., meet or attempt to meet) the ammonia storage target. For example, when the flag for adjusting the ammonia storage is enabled, the controller 100 (e.g., correction circuit 110) determines the amount of adjustment (e.g., a correction amount) to the ammonia storage. Further, the controller 100 uses the time constant to determine the duration (e.g., duration of performing the dosing operation) for adjusting the ammonia storage or when to adjust the storage (e.g., duration until the dosing operation is performed). For instance, if the time constant is 500 seconds, and the predetermined adjustment time is 100 seconds, the controller 100 can send a signal to at least one of the ammonia doser or the engine after 400 seconds to increase or reduce (or otherwise adjust) the ammonia storage, respectively. In various implementations, the controller 100 can send the signal to adjust the ammonia storage during a time duration until the temperature of the SCR catalyst 50 reaches the predicted temperature based on the time constant. In this case, the time constant (e.g., change in temperature per second or minute) can represent the duration until the current catalyst temperature reaches the predicted temperature. The adjustment can be performed gradually, continuously, intermittently, at predetermined intervals, increase or decrease at various rates, etc.

At process 510, the controller 100 (e.g., the correction circuit 110) uses or aggregates the correction amount (e.g., an amount of ammonia to increase or decrease) and the catalyst-based theta target (e.g., the ammonia storage target). The ammonia storage target (e.g., theta target) is based on the predicted temperature of the catalyst associated with the storage capacity and used to determine the ammonia storage adjustment. Upon determining the theta target based on the predicted temperature and the correction amount, the controller 100 (e.g., ammonia storage controller) adjusts, during the duration (e.g., the predetermined duration to reach the temperature or the time constant), the ammonia storage based on the received ammonia information satisfying the threshold ammonia value. In some cases, one or more parts of the controller 100 may be adjusted (e.g., by a feedforward ammonia to NOx ratio (ANR), etc.) to perform the ammonia storage adjustment.

In various implementations, the controller 100 (e.g., correction circuit 110) adjusts the ammonia storage based on the capacity of the catalyst, such as the maximum ammonia amount for the predicted temperature, or based on a desired ammonia storage amount (e.g., a minimum ammonia amount) to achieve a desired conversion efficiency of the SCR catalyst 50. In some implementations, the controller 100 adjusts the ammonia storage by increasing the ammonia storage based on the ammonia information (e.g., stored ammonia) less than the threshold ammonia value associated with the temperature of the catalyst (e.g., increase in ammonia storage capacity). In some other implementations, the controller 100 adjusts the ammonia storage by decreasing the ammonia storage based on the ammonia information greater than the threshold ammonia value associated with the temperature of the catalyst (e.g., decrease in ammonia storage capacity). The controller 100 increases the ammonia storage by initiating reductant dosing and decreases the ammonia storage by increasing the engine-out NOx, for example.

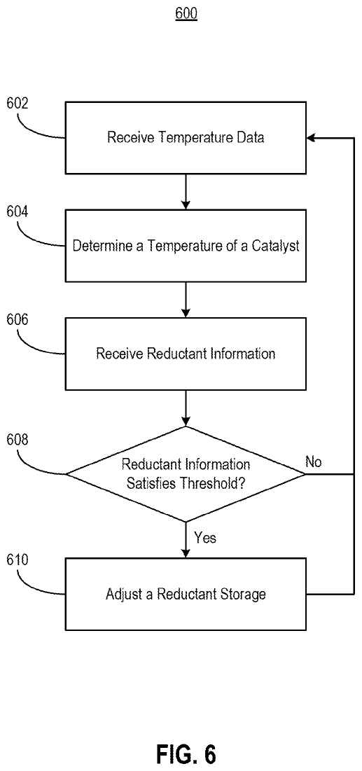

Referring now to FIG. 6, a flow diagram of a method 600 for managing ammonia emission in an aftertreatment system 22 is shown, according to an example embodiment. The method 600 may be performed by the components of FIGS. 1-2, such that reference may be made to them to aid explanation of the method 600. The method 600 can include one or more features or processes similar to the method 500, as described in conjunction with but not limited to FIG. 5. Discussed hereinafter, the method 600 includes processes 602, 604, 606, 608, and 610, among other processes (or other operations) to manage the ammonia storage in the aftertreatment system 22. In various implementations, certain processes can be performed before or after one another, such as process 604 before process 602, among others.

At process 602, the controller 100 (e.g., prediction circuit 109) receives temperature data indicative of a temperature proximate to an inlet for the aftertreatment system 22. The controller 100 can receive the temperature data from one or more temperature sensors (e.g., temperature sensors 16, 18) positioned proximate to the inlet of the aftertreatment system 22, among other locations.

At process 604, the controller 100 (e.g., prediction circuit 109) determines a temperature of the catalyst (e.g., SCR catalyst 50 or other types of catalysts) a temperature of the catalyst after a predetermined duration subsequent to the received temperature data based on the temperature data regarding the temperature proximate to the inlet for the aftertreatment system 22. The determined temperature can correspond to a predicted temperature after the predetermined duration from the time instance that the temperature data is received. For example, responsive to receiving the temperature data, the controller 100 can determine the temperature of the catalyst after 15 minutes, 30 minutes, an hour, etc. The temperature of the catalyst can refer to or correspond to a bed temperature of the catalyst.

In some implementations, to determine the temperature of the catalyst, the controller 100 can determine, based on the temperature data regarding the temperature proximate to the inlet for the aftertreatment system, a time duration for a current temperature of the catalyst to reach a predicted temperature of the catalyst, the predicted temperature satisfying a temperature threshold to adjust the reductant storage. The current temperature of the catalyst can refer to the temperature at around the time instance when the temperature data is received. The predicted temperature can be a temperature that satisfies the temperature threshold for adjusting the reductant storage, such as described in conjunction with but not limited to process 610.

At process 606, the controller 100 (e.g., prediction circuit 109) receives reductant information regarding an estimate of stored reductant in a portion of the aftertreatment system 22. The portion of the aftertreatment system 22 may be around or at the catalyst of the aftertreatment system 22, for example. At process 608, the controller 100 (e.g., prediction circuit 109) determines whether the reductant information satisfies a threshold (e.g., threshold reductant value). If the reductant information satisfies the threshold, the controller 100 can proceed to process 610 and initiate an adjustment to a reductant storage. For example, the controller 100 can determine that the received reductant information regarding the estimate of stored reductant satisfies a threshold reductant value, the threshold reductant value corresponding with the temperature of the catalyst. Responsive to the determination, the controller 100 proceeds to process 610. Otherwise, responsive to determining that the reductant information does not satisfy the threshold reductant value, the controller 100 proceeds to process 602 to continue monitoring or receiving the temperature data, for example.

At process 610, the controller 100 (e.g., dosing circuit 108, correction circuit 110, or other circuits) adjusts a reductant storage in the aftertreatment system 22 during the predetermined duration based on the received reductant information satisfying the threshold reductant value. For example, responsive to determining the time duration for the current temperature of the catalyst to reach the predicted temperature of the catalyst, where the predicted temperature satisfies the temperature threshold to adjust the reductant storage, the controller 100 can adjust, during the time duration, the reductant storage based on a reductant capacity of the catalyst associated with the predicted temperature. The reductant capacity can correspond to a maximum reductant amount or a minimum reductant amount to adjust during the time duration.

In some implementations, to adjust the reductant storage, the controller 100 can increase the reductant storage based on the reductant information being less than the threshold reductant value associated with the temperature of the catalyst or decrease the reductant storage based on the reductant information being greater than or equal to the threshold reductant value associated with the temperature of the catalyst. In some implementations, to adjust the reductant storage, the controller 100 (e.g., dosing circuit 108) can send a signal to a doser 56 to increase, decrease, or maintain a reductant dosing level.

In some implementations, to adjust the reductant storage, the controller 100 can adjust, during the predetermined duration, the reductant storage in the aftertreatment system based on the received reductant information satisfying the threshold reductant value and an exhaust flow rate. For example, the controller 100 can maintain the reductant storage when the exhaust flow rate is less than a predetermined minimum threshold. In another example, the controller 100 can increase the reductant storage when the exhaust flow rate is greater than or equal to a predetermined maximum threshold.

In some implementations, the controller 100 (e.g., aging circuit 111) can receive degradation information of the catalyst. Based on the degradation information, the controller can receive an indication of a storage capacity associated with the reductant storage. The storage capacity can be used for the controller 100 to adjust the reductant storage, for example.

It should be understood that no claim element herein is to be construed under the provisions of 35 U.S.C. § 112(f), unless the element is expressly recited using the phrase “means for.” The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams. Further, reference throughout this specification to “one embodiment”, “an embodiment”, “an example embodiment”, or similar language means that a particular feature, structure, or characteristic described in connection with the embodiment is included in at least one embodiment of the present invention. Thus, appearances of the phrases “in one embodiment”, “in an embodiment”, “in an example embodiment”, and similar language throughout this specification may, but do not necessarily, all refer to the same embodiment.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Many of the functional units described in this specification have been labeled as circuits, in order to more particularly emphasize their implementation independence. For example, a circuit may be implemented as a hardware circuit comprising custom very-large-scale integration (VLSI) circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

As mentioned above, circuits may also be implemented in machine-readable medium for execution by various types of processors, such as processor 102 of FIG. 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

The computer readable medium (also referred to herein as machine-readable media or machine-readable content) may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. As alluded to above, examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. As also alluded to above, computer readable program code embodied on a computer readable signal medium may be transmitted using any appropriate medium, including but not limited to wireless, wireline, optical fiber cable, Radio Frequency (RF), or the like, or any suitable combination of the foregoing. In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on a local computer (such as via the controller 100 of FIGS. 1 and 2), partly on the local computer, as a stand-alone computer-readable package, partly on the local computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A system comprising:
an aftertreatment system including a catalyst;
a controller coupled to at least the aftertreatment system, the controller configured to:
receive temperature data indicative of a temperature proximate to an inlet for the aftertreatment system;
determine, based on the temperature data regarding the temperature proximate to the inlet for the aftertreatment system, a temperature of the catalyst after a predetermined duration subsequent to the received temperature data;
receive reductant information regarding an estimate of stored reductant in a portion of the aftertreatment system;
determine that the received reductant information regarding the estimate of stored reductant satisfies a threshold reductant value, the threshold reductant value corresponding with the temperature of the catalyst; and
adjust, during the predetermined duration, reductant storage in the aftertreatment system based on the received reductant information satisfying the threshold reductant value.

2. The system of claim 1, wherein to determine the temperature of the catalyst, the controller is further configured to:
determine, based on the temperature data regarding the temperature proximate to the inlet for the aftertreatment system, a time duration for a current temperature of the catalyst to reach a predicted temperature of the catalyst, the predicted temperature satisfying a temperature threshold to adjust the reductant storage; and
adjust, during the time duration, the reductant storage based on a reductant capacity of the catalyst associated with the predicted temperature.

3. The system of claim 2, wherein the reductant capacity corresponds to a maximum reductant amount to adjust during the time duration.

4. The system of claim 2, wherein the reductant capacity corresponds to a minimum reductant amount to adjust during the time duration.

5. The system of claim 1, wherein to adjust the reductant storage, the controller is configured to:
increase the reductant storage based on the reductant information being less than the threshold reductant value associated with the temperature of the catalyst.

6. The system of claim 1, wherein to adjust the reductant storage, the controller is configured to:
decrease the reductant storage based on the reductant information being greater than or equal to the threshold reductant value associated with the temperature of the catalyst.

7. The system of claim 1, wherein to adjust the reductant storage, the controller is configured to:
send a signal to a doser to increase, decrease, or maintain a reductant dosing level.

8. The system of claim 1, wherein to adjust the reductant storage, the controller is configured to:
adjust, during the predetermined duration, the reductant storage in the aftertreatment system based on the received reductant information satisfying the threshold reductant value and an exhaust flow rate.

9. The system of claim 8, wherein the controller is configured to:
maintain the reductant storage when the exhaust flow rate is less than a predetermined minimum threshold.

10. The system of claim 8, wherein the controller is configured to:
increase the reductant storage when the exhaust flow rate is greater than or equal to a predetermined maximum threshold.

11. The system of claim 1, wherein the temperature of the catalyst is a bed temperature of the catalyst.

12. The system of claim 1, wherein the controller is configured to:
receive degradation information of the catalyst; and
receive, based on the degradation information, an indication of a storage capacity associated with the reductant storage, wherein the reductant storage is adjusted based on the storage capacity.

13. A method comprising:
receiving, by a controller coupled to an aftertreatment system including a catalyst, temperature data indicative of a temperature proximate to an inlet for the aftertreatment system;
determining, by the controller, based on the temperature data regarding the temperature proximate to the inlet for the aftertreatment system, a temperature of the catalyst after a predetermined duration subsequent to the received temperature data;
receiving, by the controller, reductant information regarding an estimate of stored reductant in a portion of the aftertreatment system;
determining, by the controller, that the received reductant information regarding the estimate of stored reductant satisfies a threshold reductant value, the threshold reductant value corresponding with the temperature of the catalyst; and
adjusting, by the controller, during the predetermined duration, reductant storage in the aftertreatment system based on the received reductant information satisfying the threshold reductant value.

14. The method of claim 13, wherein determining the temperature of the catalyst comprises:
determining, by the controller, based on the temperature data regarding the temperature proximate to the inlet for the aftertreatment system, a time duration for a current temperature of the catalyst to reach a predicted temperature of the catalyst, the predicted temperature satisfying a temperature threshold to adjust the reductant storage; and
adjusting, by the controller, during the time duration, the reductant storage based on a reductant capacity of the catalyst associated with the predicted temperature.

15. The method of claim 14, wherein the reductant capacity corresponds to a maximum reductant amount to adjust during the time duration.

16. The method of claim 14, wherein the reductant capacity corresponds to a minimum reductant amount to adjust during the time duration.

17. The method of claim 13, wherein adjusting the reductant storage comprises:
increasing the reductant storage based on the reductant information being less than the threshold reductant value associated with the temperature of the catalyst.

18. The method of claim 13, wherein adjusting the reductant storage comprises:
decreasing the reductant storage based on the reductant information being greater than or equal to the threshold reductant value associated with the temperature of the catalyst.

19. A processing circuit structured to manage reductant slip in an aftertreatment system, the processing circuit comprising:
one or more processors; and
one or more memory devices coupled to the one or more processors, the one or more memory devices storing instructions that, when executed by the one or more processors, cause the one or more processors to:
receive temperature data indicative of a temperature proximate to an inlet for the aftertreatment system;
determine, based on the temperature data regarding the temperature proximate to the inlet for the aftertreatment system, a temperature of a catalyst after a predetermined duration subsequent to the received temperature data;
receive reductant information regarding an estimate of stored reductant in a portion of the aftertreatment system;
determine that the received reductant information regarding the estimate of stored reductant satisfies a threshold reductant value, the threshold reductant value corresponding with the temperature of the catalyst; and
adjust, during the predetermined duration, reductant storage in the aftertreatment system based on the received reductant information satisfying the threshold reductant value.

20. The processing circuit of claim 19, wherein to adjust the reductant storage, the instructions, when executed by the one or more processors, further cause the one or more processors to:
send a signal to a doser to increase, decrease, or maintain a reductant dosing level.
